(19) United States
(12) Patent Application Publication
(10) Pub. No.: US 2015/0193004 A1
(43) Pub. Date: Jul. 9, 2015

(54) APPARATUS AND METHOD FOR CONTROLLING A PLURALITY OF TERMINALS USING ACTION RECOGNITION

(71) Applicant: Samsung Electronics Co., Ltd., Gyeonggi-do (KR)

(72) Inventors: Moonsoo KIM, Seoul (KR); Kwangtai KIM, Gyeonggi-do (KR); Dasom LEE, Seoul (KR)

(21) Appl. No.: 14/585,756

(22) Filed: Dec. 30, 2014

(30) Foreign Application Priority Data
Jan. 6, 2014 (KR) 10-2014-0001089

(51) Int. Cl. G06F 3/01

(52) U.S. Cl. CPC G06F 3/017

(57) ABSTRACT

An apparatus and method for controlling a plurality of terminals using a gesture recognition. The method includes recognizing a gesture by using an action sensor; verifying an angle of a paired second terminal; deciding an input signal by combining the gesture and the angle; and controlling a first terminal in response to the decided input signal.

### CROSS-REFERENCE TO RELATED APPLICATION

The present application is related to and claims priority from and the benefit under 35 U.S.C. §119(a) of Korean Patent Application No. 10-2014-0001089, filed on Jan. 6, 2014, which is hereby incorporated by reference for all purposes as if fully set forth herein.

### TECHNICAL FIELD

The present embodiment relates to a method for controlling a terminal by using an action recognition.

### BACKGROUND

In general, a method of detecting an action in a portable terminal uses a method of recognizing an up, down, left or right action in a single portable terminal, or detecting a specific action using a camera. That is, a conventional technology recognizes an action in a single terminal, and performs a function corresponding to the recognized action.

In the related art, an action is recognized in a single terminal, and a function corresponding to the recognized action is performed. However, a method for controlling a plurality of terminals by recognizing an action in a plurality of terminals is not used. Therefore, the same action must be repeated for several times in order to control a plurality of terminals by using an action recognition.

### SUMMARY

The present disclosure may provide a method and an apparatus for controlling a plurality of terminals using an action recognition that can control a plurality of terminals with only a single action.

In accordance with an aspect of an embodiment of the present invention, a method for controlling a plurality of terminals using a gesture recognition includes recognizing a gesture by using an action sensor; verifying an angle of a paired second terminal; deciding an input signal by combining the gesture and the angle; and controlling a first terminal in response to the decided input signal.

In accordance with another aspect of an embodiment of the present invention, an apparatus for controlling a plurality of terminals using a gesture recognition includes: an action sensor to recognize a gesture of an object; an angle verification unit to verify an angle of a paired second terminal; an input decision unit to determine an input signal by combining the gesture and the angle; and a controller to control a first terminal in response to the decided input signal.

### BRIEF DESCRIPTION OF THE DRAWINGS

The present disclosure will be more apparent from the following detailed description in conjunction with the accompanying drawings, in which:

FIG. 1 is a flowchart illustrating an example method for controlling a plurality of terminals using an action recognition according to an embodiment of the present disclosure;

FIG. 2 is a diagram illustrating an example placement position of terminals according to an embodiment of the present disclosure;

FIG. 3 is a diagram illustrating an example of recognizing an action by using an action sensor according to an embodiment of the present disclosure;

FIG. 4 is a diagram illustrating examples of controlling a terminal corresponding to an input signal according to an action and an angle according to an embodiment of the present disclosure;

FIG. 5 is a diagram illustrating examples of controlling a terminal corresponding to an input signal according to an action and an angle according to an embodiment of the present disclosure;

FIG. 6 is a diagram illustrating examples of controlling a terminal corresponding to an input signal according to an action and an angle according to an embodiment of the present disclosure;

FIG. 7 is a diagram illustrating examples of controlling a terminal corresponding to an input signal according to an action and an angle according to an embodiment of the present disclosure;

FIG. 8 is a flowchart illustrating an example method for controlling a plurality of terminals using an action recognition according to another embodiment of the present disclosure;

FIG. 9 is a flowchart illustrating an example method for controlling a plurality of terminals using an action recognition according to another embodiment of the present disclosure;

FIG. 10 is a diagram illustrating an example of recognizing an action by using a camera according to another embodiment of the present disclosure; and

FIG. 11 is a block diagram illustrating an example apparatus for controlling a plurality of terminals using an action recognition according to an embodiment of the present disclosure.

### DETAILED DESCRIPTION

Embodiments of the present disclosure are described with reference to the accompanying drawings in detail. The same reference numbers are used throughout the drawings to refer to the same or like parts. For the purposes of clarity and simplicity, detailed descriptions of well-known functions and structures incorporated herein may be omitted to avoid obscuring the subject matter of the present disclosure.

A plurality of terminal control apparatuses using a motion recognition of the present disclosure may be included in an electronic device. An electronic device according to the present disclosure may be a device including a communication function. For example, the device corresponds to a combination of at least one of a smartphone, a tablet Personal Computer (PC), a mobile phone, a video phone, an e-book reader, a desktop PC, a laptop PC, a netbook computer, a Personal Digital Assistant (PDA), a Portable Multimedia Player (PMP), a digital audio player, a mobile medical device, an electronic bracelet, an electronic necklace, an electronic accessory, a camera, a wearable device, an electronic clock, a wrist watch, home appliances (for example, e.g., an air-conditioner, vacuum, an oven, a microwave, a washing machine, an air cleaner, and/or the like), an artificial intelligence robot, a TeleVision (TV), a Digital Video Disk (DVD) player, an audio device, various medical devices (for example, e.g., Magnetic Resonance Angiography (MRA), Magnetic Resonance Imaging (MRI), Computed Tomography (CT), a scanning machine, an ultrasonic wave device, and/or the like), a navigation device, a Global Positioning System (GPS) receiver, an Event Data Recorder (EDR), a Flight Data Recorder (FDR), a set-top box, a TV box (for example, e.g., Samsung HomeSync™, Apple TV™, or Google TV™), an electronic dictionary, vehicle infotainment device, an electronic equipment for a ship (for example, e.g., navigation equipment for a ship, gyrocompass, and/or the like), avionics, a security device, electronic clothes, an electronic key, a camcorder, game consoles, a Head-Mounted Display (HMD), a flat panel display device, an electronic frame, an electronic album, furniture or a portion of a building/structure that includes a communication function, an electronic board, an electronic signature receiving device, a projector, and/or the like. It is obvious to those skilled in the art that the electronic device according to the present disclosure is not limited to the aforementioned devices.

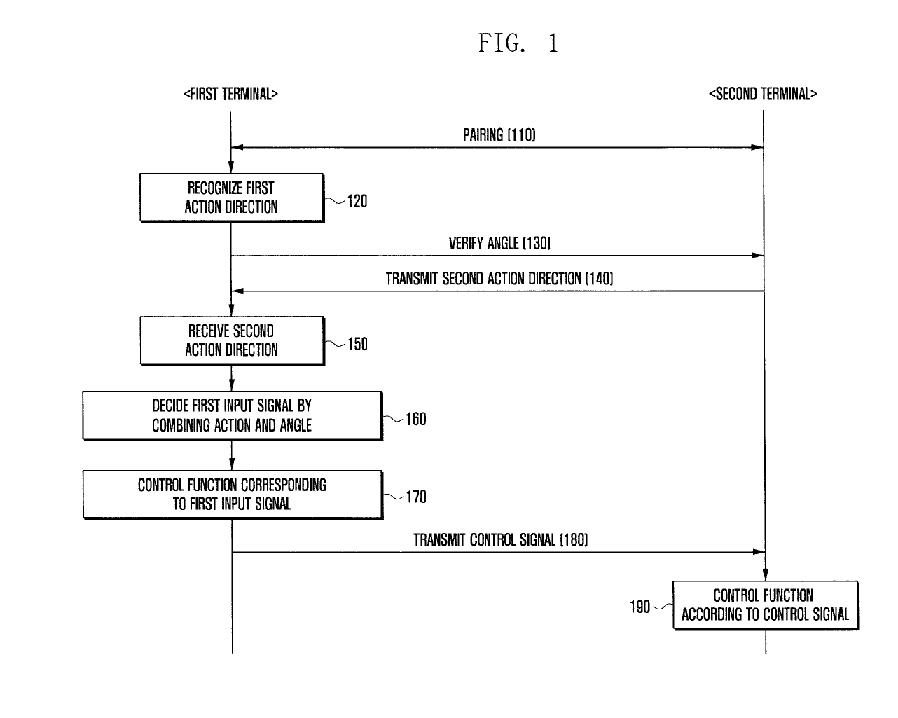

FIG. 1 is a flowchart illustrating a method for controlling a plurality of terminals using an action recognition according to an example embodiment of the present disclosure. The method for controlling a plurality of terminals using the action recognition may be included in a first terminal or a second terminal. The first terminal and the second terminal may be the above mentioned electronic apparatus.

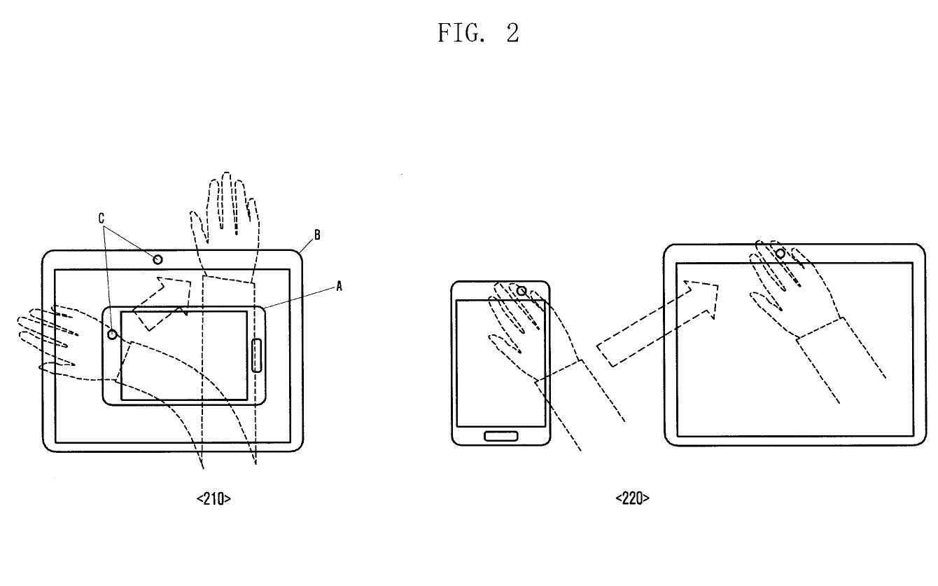

Referring to FIG. 1, at operation 110, the first terminal and the second terminal may perform a pairing. The pairing may prepare the first terminal and the second terminal to be controlled with a single action recognition, while the first terminal and the second terminal are in network communication. Pairing methods may be provided by technologies such as Near Field Communication (NFC), Bluetooth, or the like. In addition, although two terminals are described in the example of FIG. 2, the invention is not limited to utilization of two terminals as a plurality of terminals may be controlled by using action recognition after pairing the plurality of terminals.

At operation 120, the first terminal may recognize an action using an action sensor. The action sensor may be implemented any of various sensors that are capable of detecting an action of an object. For example, the action sensor may be any one of an infrared sensor, a proximity sensor, a gyroscopic sensor, an optical sensor, a motion sensor, a gravity sensor, an illumination sensor, or a camera. The action sensor may be mounted in the first terminal or the second terminal. For example, the action sensor may be mounted on an upper portion of the first terminal. The object may be a person or a thing, and, hereinafter, a user's hand will be utilized as an example. The action may be a gesture or a motion of the user's hand. The first terminal may recognize an action direction of the hand using the action sensor. Here, the direction of movement of the hand recognized in the first terminal may be referred to as a “first action direction.”

FIG. 2 is a diagram illustrating a placement position of terminals according to an example embodiment of the present disclosure.

Referring to FIG. 2, the first terminal (A) and the second terminal (B) may be disposed with one overlapping the other (210). The action sensor (C) may be mounted in an upper portion of the first terminal (A) or the second terminal (B) respectively. As in 210, when the first terminal (A) and the second terminal (B) overlap as depicted, the first terminal (A) and the second terminal (B) may be controlled with a single action. For example, the first terminal (A) and the second terminal (B) may be controlled by recognizing the hand action as depicted (210). Thus, when the first terminal (A) and the second terminal (B) are arranged to be overlapping, ease of use for a user is increased because a moving distance of the user's hand is the shortest. In addition, since the action sensor (C) is mounted in the upper portion of the first terminal (A) or the second terminal (B), it is simpler to determine a direction of movement of the hand for a counterpart terminal when the first terminal (A) and the second terminal (B) are overlapped.

In another arrangement, the first terminal (A) and the second terminal (B) may be disposed adjacently within a certain distance (D) of one another (220). When the first terminal (A) and the second terminal (B) are disposed thusly within the distance (D), the user may utilize large hand movements so that both action sensors of the first terminal (A) and the second terminal (B) may detect and recognize the hand action. The first terminal (A) and the second terminal (B) may recognize the movement direction of the hand either simultaneously (210) or within a specific time frame (220), which aids in determining that it is the same movement detected by both the first terminal (A) and the second terminal (B).

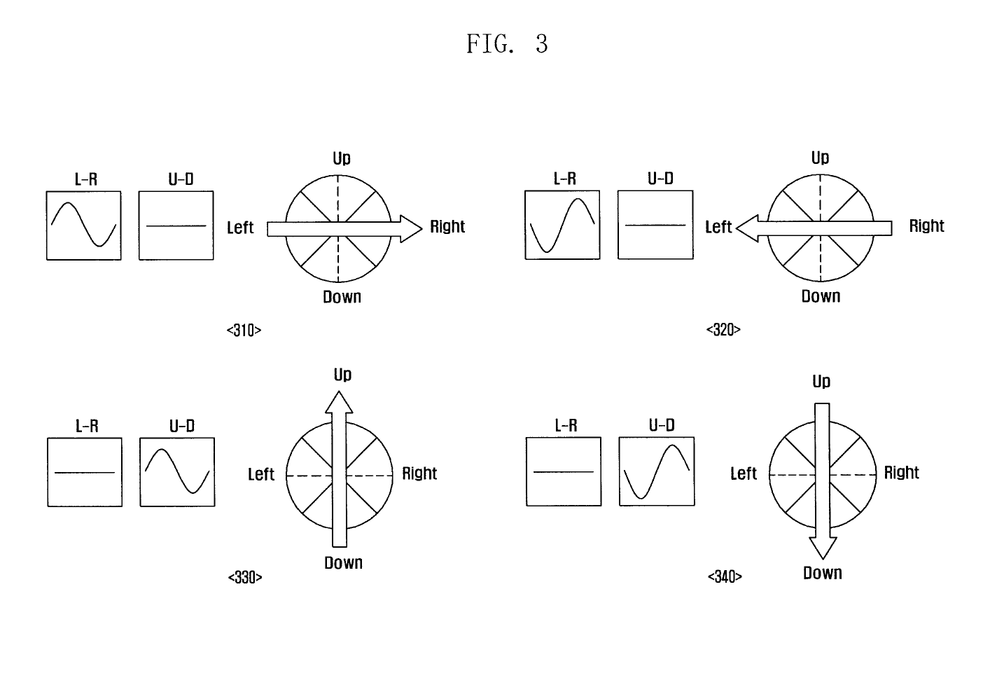

FIG. 3 is a diagram illustrating an example of recognizing an action by using an action sensor according to an example embodiment of the present disclosure.

Referring to FIG. 3, the action sensor may recognize the direction of a hand movement from left to right (310). In this case, a waveform of the rightward direction (L-R) may be generated and detected, whereas other waveforms, such as one for an up and down direction, do not occur. The action sensor may similarly recognize a leftwards movement of the hand from right to the left (320). In this case, the leftwards waveform may have a phase difference with a rightwards movement (310). For example, the rightwards (310) waveform may be a sine wave, and the leftwards (320) waveform may be a cosine wave. Alternatively, the rightwards (310) waveform may be a sine wave, and leftwards (320) waveform may have a 180-degree phase difference with the sine wave.

The action sensor may recognize an upwards (330) movement of the hand from down to up. In this case, an upwards (U-D) waveform may be generated and detected, and the leftwards or rightwards waveforms may not be generated or detected. The action sensor may similarly recognize a downwards (340) movement of the hand from up to down. In this case, a downwards (340) waveform having a different phase difference with an upwards (330) waveform may be generated and detected. For example, the upwards (330) waveform may be a cosine wave, and the downwards (340) waveform may be a sine wave. Alternatively, the upwards (330) waveform may be a cosine wave, and the downwards (340) waveform may have a 180-degree phase difference with the cosine wave.

At operation 130, the first terminal may verify an angle of the paired second terminal. The first terminal may request an angle to the second terminal so as to verify an angle difference with the second terminal.

At operation 140, the second terminal may transmit a second action direction to the first terminal after the second terminal detects the second action direction. The second action direction may be detected by using the action sensor in the second terminal. Here, the action direction recognized in the second terminal may be referred to as a second action direction.

At operation 150, the first terminal may receive the second action direction. The first terminal may verify an angle difference with the second terminal by using the first action direction and the second action direction.

At operation 160, the first terminal may determine an input signal by combining the first action direction and second action direction with consideration given to the angle difference. For example, the first terminal may determine a first input signal was indicated by combining the first action direction recognized at operation 120 and the second action direction received at operation 150.

In one example embodiment, the first terminal may determine the desired first input signal with reference to the angle difference and an input table. As described previously, the first action direction indicates the direction of a hand movement detected by the first terminal, and the second action indicates the direction of the same hand movement detected in the second terminal. The input table may be a table stored in memory where respective input signals are related, associated or correlated to the first action direction and the second action direction.

At operation 170, the first terminal may control a function in response to the determined first input signal. The function may relate to or control an application installed in the first terminal or the second terminal, or involve stored data. The stored data may include interchangeable data such as an application, a content, a text, an image, a video, a phone number, a message, or the like. Alternatively, execution of the function may involve the functions such as copy, move, cancel (or a delete), entering or selecting a link, or the like, as controlled by the first terminal.

At operation 180, the first terminal may transmit a control signal related to the controlled function to the second terminal.

At operation 190, the second terminal may control a function that is controlled in the first terminal according to the control signal.

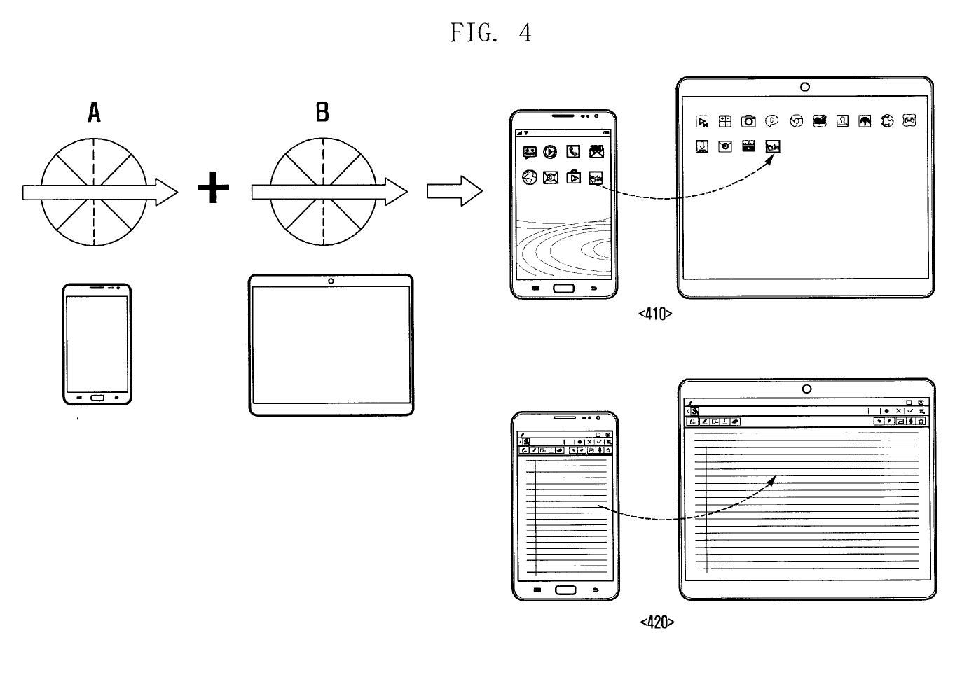

FIGS. 4 to 7 are diagrams illustrating examples of controlling a terminal corresponding to an input signal according to an action and an angle according to an embodiment of the present disclosure.

Referring to FIG. 4, the first terminal (A) may perform a “copy” function in response to an input signal having a 0° angle difference between a rightwards movement, or a movement from the left to the right as detected by the first terminal (A) and the second terminal (B). The angle difference may be detected based on matching or different orientations of the first terminal (A) and second terminal (B) relative to one another.

Here, the first terminal (A) may detect that the angle difference is 0° when the angle difference with the second terminal (B) is 0°˜below 90°, or −45°˜below 45°, and may determine the input signal is indicating a particular function. For example, the first terminal (A) may determine function such as copying an application stored in the first terminal (A) to the second terminal (B) at operation 410. The first terminal (A) may receive a selection of the application to be copied from the user, and then copy the selected application to the second terminal (B). At this time, the application copied to the second terminal (B) may remain as it is in the first terminal (A). Alternatively, the first terminal (A) may execute the selected data, and the executed data may be also executed in the second terminal at operation 420. That is, the first terminal (A) may execute a memo pad in response to the input signal, and may transmit the control signal to the second terminal (B) so that the executed memo pad may be also executed in the second terminal (B).

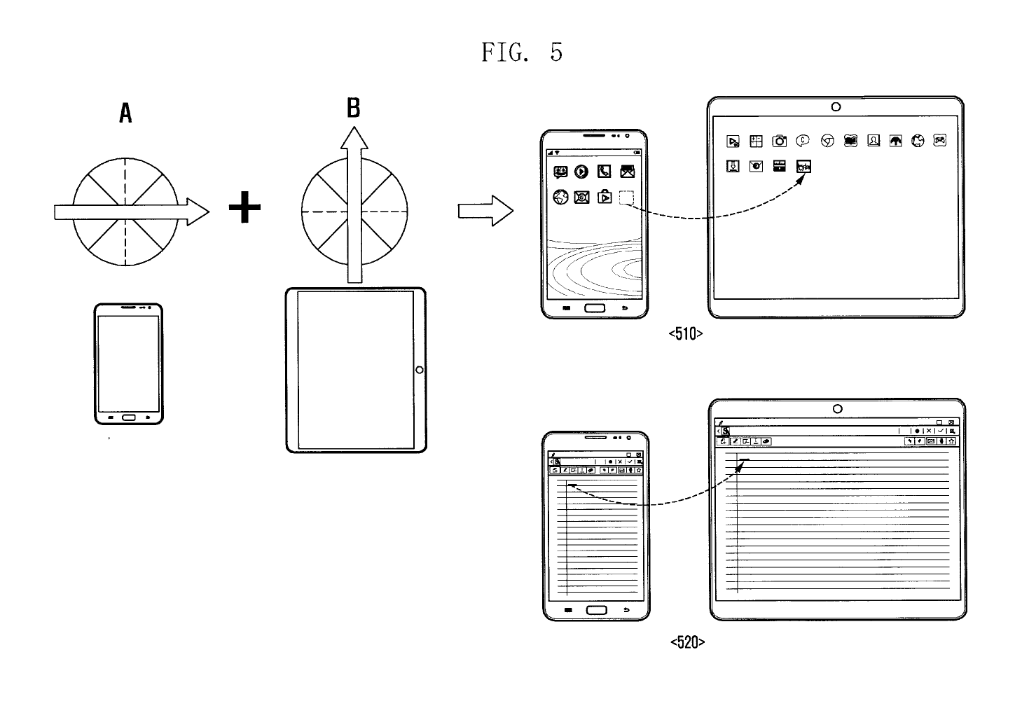

Referring to FIG. 5, the first terminal (A) may also perform a “move” function in response to an input signal having a 90° angle difference between a rightwards movement from the left to the right and the same movement as detected in the second terminal (B). Here, the first terminal (A) may determine that the angle difference is 90° even though the angle difference with the second terminal (B) is 90°˜below 180°, or 45°˜below 135°, and may decide the input signal. For example, the first terminal (A) may move the application stored in the first terminal (A) to the second terminal (B) at operation 510. In this case, the application moved to the second terminal (B) may be deleted from the first terminal (A). Alternatively, when the executed data is related to a text such as a “memo pad” or a “message”, the first terminal (A) may move a blinking cursor in the first terminal (A) to the second terminal (B) at operation 520.

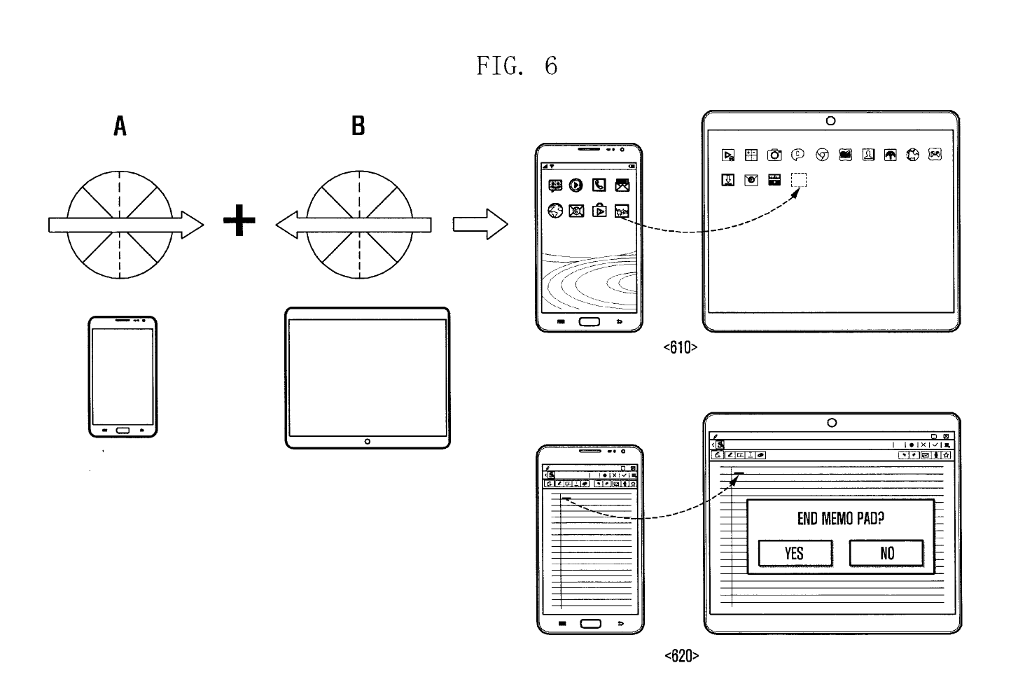

Referring to FIG. 6, the first terminal (A) may also perform a “cancel” function in response to an input signal having a 180° angle difference between a rightwards movement from the left to the right and the second terminal (B). Here, the first terminal (A) may decide that the angle difference is 180° even though the angle difference with the second terminal (B) is 180°˜below 270°, or 135°˜below 315°, and may determine the input signal. For example, the first terminal (A) may cancel a data which is being executed in the first terminal at operation 610. If the application is being copied to the second terminal (B), the first terminal (A) may cancel the copy. Alternatively, the first terminal (A) may delete or terminate the data being executed at operation 620.

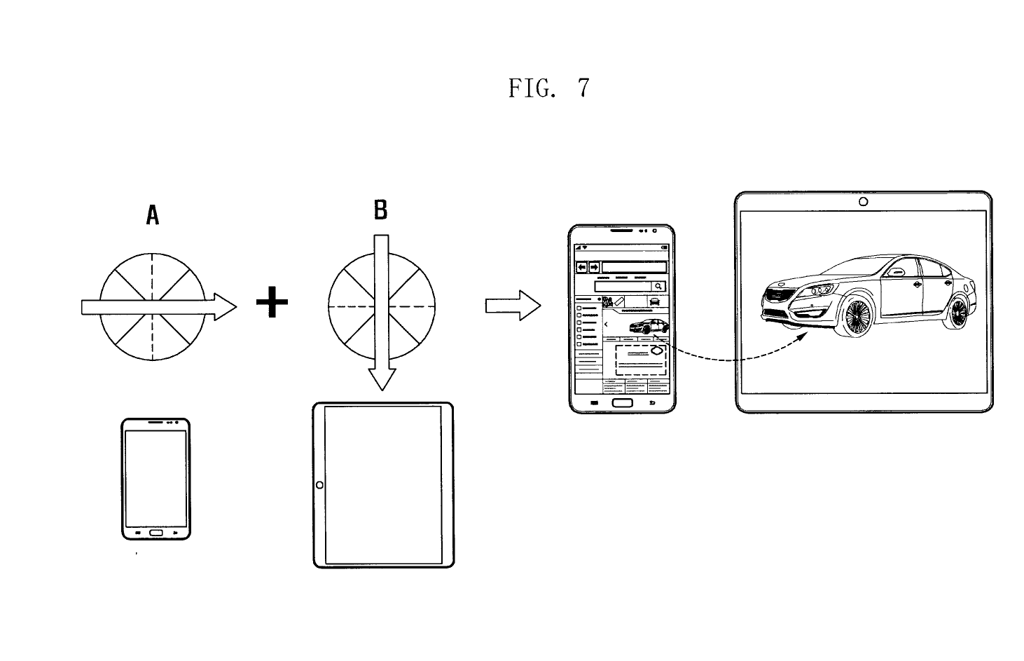

Referring to FIG. 7, the first terminal (A) may perform a “link” function in response to an input signal having a 270° angle difference between a rightwards direction from the left to the right and the second terminal (B). Here, the first terminal (A) may determine that the angle difference is 270° even though the angle difference with the second terminal (B) is 270°˜below 360°, or 315°˜below −45°, and may decide the input signal. For example, the first terminal (A) may provide a link page of the connected page to the second terminal (B), where the link page may be opened. For example, when there is a link page in the page displayed upon or within the first terminal (A), the link information may be transmitted to the second terminal (B) and then opened by the second terminal (B) when user makes the relevant hand action.

In FIGS. 1 to 7, it is illustrated that the first terminal controls the second terminal according to the function performance. However, the second terminal may also control the first terminal according to the function performance.

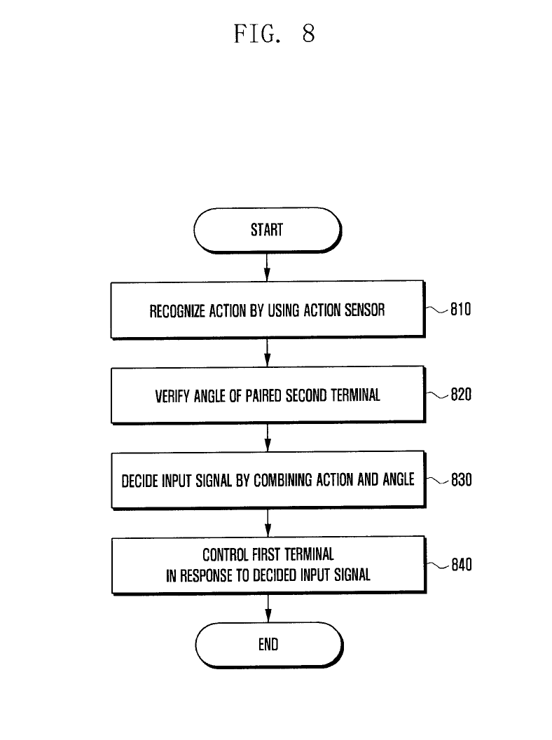

FIG. 8 is a flowchart illustrating an example method for controlling a plurality of terminals using an action recognition according to another embodiment of the present disclosure.

The method for controlling a plurality of terminals using an action recognition may be performed in an apparatus for controlling a plurality of terminals (hereinafter, referred to as a “terminal control apparatus”) using an action recognition.

Referring to FIG. 8, at operation 810, the terminal control apparatus may recognize an action by using an action sensor. The action sensor may include various sensors that can detect an action of an object. For example, the action sensor may be any one of an infrared sensor, a proximity sensor, a gyro sensor, an optical sensor, a motion sensor, a gravity sensor, an illumination sensor, or a camera. In the embodiment, the terminal control apparatus may recognize the action direction of the object by using the action sensor.

At operation 820, the terminal control apparatus may verify an angle of the paired second terminal. The terminal control apparatus may be included in the first terminal, and the second terminal may be a terminal paired with the terminal control apparatus. The pairing is to control the first terminal and the second terminal only with a single action recognition, while the first terminal and the second terminal are interworked. In the embodiment, the terminal control apparatus may receive the action direction of the second terminal from the second terminal by requesting an angle to the second terminal.

At operation 830, the terminal control apparatus may decide an input signal by combining the action and the angle. The terminal control apparatus may calculate an angle difference between the terminal control apparatus and the second terminal by using the first action direction recognized in the terminal control apparatus and the received second action direction. The terminal control apparatus may determine the appropriate input signal or function invocation with respect of the angle difference. In the embodiment, the terminal control apparatus may decide the input signal corresponding to the angle difference, the first action direction, and the second action direction with reference to the input table. The input table may be a memory where input signals related to the first action direction and the second action direction are stored.

At operation 840, the terminal control apparatus may control the first terminal in response to the decided input signal. That is, since the terminal control apparatus is included in the first terminal, the terminal control apparatus may control the function corresponding to the input signal. For example, the terminal control apparatus may execute a first function corresponding to the first input signal when the decided input signal is the first input signal, or may execute a second function corresponding to the second input signal when the decided input signal is the second input signal. Each function that is executed for each input signal may be stored in the input table.

By transmitting the control signal related to the controlled function to the second terminal, the terminal control apparatus enables the second terminal to execute a same, related or associated function that was executed in the first terminal in response to the control signal.

In the embodiment, the method for recognizing an action by the terminal control apparatus may be differentiated according to any one of the recognized action speed, a sample rate, a distance between the paired terminals, a size of an object, or a height of a threshold value of action sensor.

For example, the terminal control apparatus may recognize the action direction by lowering the sample rate when the action speed is slow, or may recognize the action direction by lowering the action speed when a distance between the paired terminals is long. Alternatively, the terminal control apparatus may recognize even a small action by lowering a threshold value of the action sensor when a size of the object is small.

Thus, according to the present disclosure, a plurality of terminals may be controlled only with a single action.

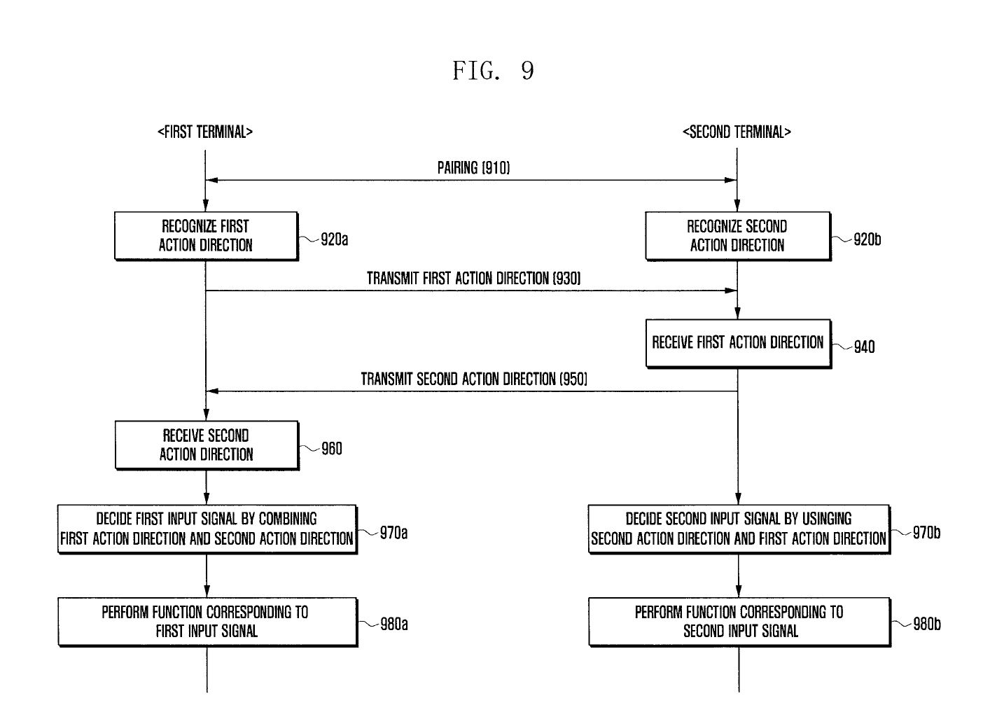

Hereinafter, in FIG. 9, another example embodiment of a method for controlling each terminal by using an action recognition between the first terminal and the second terminal will be described.

FIG. 9 is a flowchart illustrating a method for controlling a plurality of terminals using an action recognition according to another embodiment of the present disclosure.

Referring to FIG. 9, at operation 910, the first terminal and the second terminal may perform a pairing, and thus be communicably networked to one another.

At operation 920A, the first terminal may recognize the first action direction by using a first action sensor. In addition, at operation 920B, the second terminal may recognize the second action direction by using a second action sensor. That is, the first terminal and the second terminal may recognize each action direction simultaneously or within a threshold time by using their respective action sensors. As described above, the action direction recognized by the first terminal may be the first action direction, and the action direction recognized by the second terminal may be the second action direction.

At operation 930, the first terminal may transmit the first action direction to the second terminal.

At operation 940, the second terminal may receive the first action direction.

At operation 950, the second terminal may transmit the second action direction to the first terminal.

At operation 960, the first terminal may receive the second action direction.

At operation 970A, the first terminal may determine the first input signal to be executed by using the first action direction and the second action direction. The first terminal may verify an angle difference between the first terminal and the second terminal by using the first action direction and the second action direction. Therefore, the first terminal may decide a first input signal with reference to the angle difference and the input table.

At operation 970B, the second terminal may determine a second input signal to be executed by using the second action direction and the first action direction. Additionally, in some embodiments, the second terminal may also verify the angle difference between the first terminal and the second terminal by using the first action direction and the second action direction. Accordingly, the second terminal may determine the second input signal with reference to the angle difference and the input table.

As described above, the first input signal is an input signal determined in the first terminal, and the second input signal is an input signal decided in the second terminal.

At operation 980A, the first terminal may execute a function corresponding to the determined first input signal. At operation 980B, the second terminal may perform a function corresponding to the second input signal. For example, when the first input signal is a “copy” function, the first terminal may copy the stored data to the second terminal. Similarly, the second terminal may copy the stored data to the first terminal.

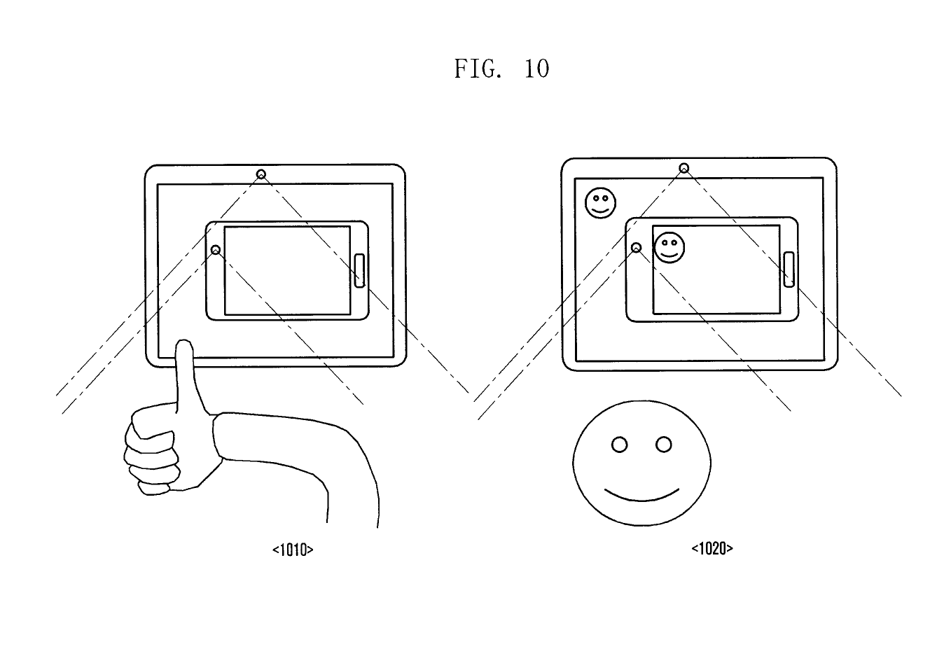

FIG. 10 is a diagram illustrating an example of recognizing an action by using a camera according to another embodiment of the present disclosure.

Referring to FIG. 10, the terminal control apparatus may control the first terminal or the second terminal by recognizing, for example, a “thumbs up” action using the camera (1010). Alternatively, the terminal control apparatus may control the first terminal or the second terminal by recognizing a smiling of a user's face using the camera (1020). For example, the camera may recognize the action by using feature points to detect aspects of images captured by the camera, or may compare the photographed image with a stored image pattern to recognize whether it is a thumb up action or a smiling face. Accordingly, the terminal control apparatus may determine the desired input signal by calculating, for example, the “thumbs up” action and the angle difference to the second terminal, and may perform the function corresponding to the determined input signal. Alternatively, the terminal control apparatus may decide the input signal by using the angle difference between the smiling face and the second terminal, and may perform the function corresponding to the decided input signal.

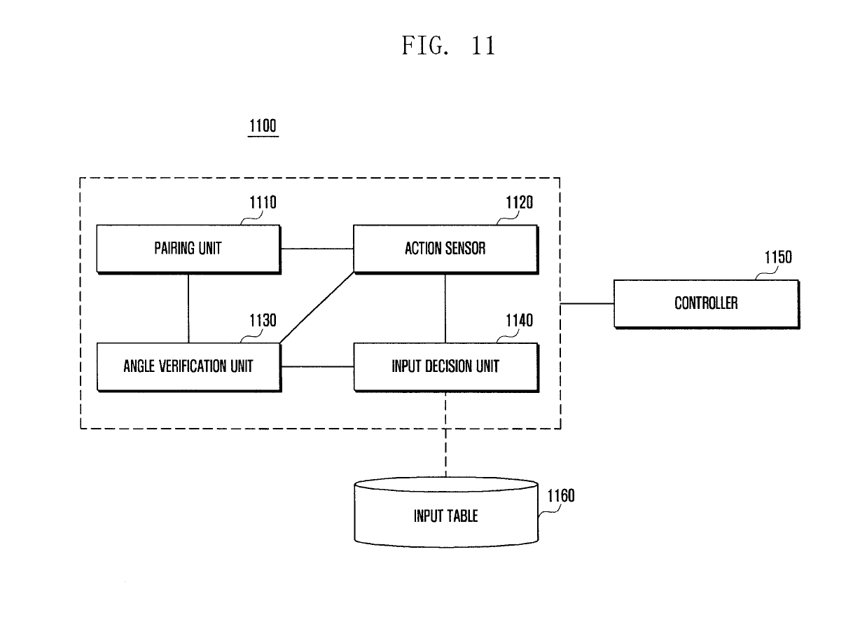

FIG. 11 is a block diagram illustrating an apparatus for controlling a plurality of terminals using an action recognition according to an embodiment of the present disclosure.

Referring to FIG. 11, the apparatus for controlling a plurality of terminals (hereinafter, referred to as a ‘terminal control apparatus’ 1100) using an action recognition may include a pairing unit 1110, an action sensor 1120, an angle verification unit 1130, an input decision unit 1140, a controller 1150, and an input table 1160.

The pairing unit 1110 may perform a pairing with the second terminal to be controlled along with the terminal control apparatus 1100. The pairing unit 1110 may perform a pairing with the second terminal by using various pairing methods such as a near field communication unit, a Bluetooth unit, or the like.

The action sensor 1120 may detect an action or movement of an object. The action sensor 1120 may be any one of an infrared sensor, a proximity sensor, a gyro sensor, an optical sensor, a motion sensor, a gravity sensor, an illumination sensor, or a camera. The object may be a person or a thing, or a portion thereof. Hereinafter, a user's hand will be utilized as an example object. The action may be a gesture or a motion of the user's hand. The action sensor 1120 may also recognize a movement direction of the user's hand.

The angle verification unit 1130 may verify an angle of the second terminal relative to the first terminal. The angle verification unit 1130 may verify the angle difference between the terminal control apparatus 1100 and the second terminal based on the second action direction of the second terminal received from the second terminal and the first action direction recognized in the action sensor 1120.

The input decision unit 1140 may determine the input signal to be executed by combining the first action, the second action (and their respective directions) and the angle. In the embodiment, the input decision unit 1140 may determine the appropriate input signal correlating to the analysis with reference to the angle difference and the input table 1160.

The input table 1160 may be a table stored in memory where respective input signals related to the first action direction and the second action direction are stored.

The controller 1150 may execute on the first terminal the determined input signal as retrieved from the input table 1160. The first terminal may include the terminal control apparatus 1100. Therefore, the controller 1150 may execute a function in response to the input signal, including operations like copy, move, cancel (or a delete), a link, or the like by controlling the first terminal in response to the decided input signal. The function may be an application installed in the first terminal or the second terminal, or a stored data. The data may mean all exchangeable data such as an application, a content, a text, an image, a video, a telephone number, and a message.

According to an embodiment of the present disclosure, a plurality of terminals may be controlled with only a single action.

Although embodiments of the present disclosure have been described in detail hereinabove, it should be clearly understood that many variations and modifications of the basic inventive concepts herein taught which may appear to those skilled in the present art will still fall within the ambit of the present disclosure, as defined in the appended claims.

The above-described embodiments of the present disclosure can be implemented in hardware, firmware or via the execution of software or computer code that can be stored in a recording medium such as a CD ROM, a Digital Versatile Disc (DVD), a magnetic tape, a RAM, a floppy disk, a hard disk, or a magneto-optical disk or computer code downloaded over a network originally stored on a remote recording medium or a non-transitory machine readable medium and to be stored on a local recording medium, so that the methods described herein can be rendered via such software that is stored on the recording medium using a general purpose computer, or a special processor or in programmable or dedicated hardware, such as an ASIC or FPGA.

As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

Any of the functions and steps provided in the Figures may be implemented in hardware, software or a combination of both and may be performed in whole or in part within the programmed instructions of a computer. No claim element herein is to be construed under the provisions of 35 U.S.C. 112, sixth paragraph, unless the element is expressly recited using the phrase “means for”.

In addition, an artisan understands and appreciates that a “processor” or “microprocessor” refer to hardware in the claimed disclosure. Under the broadest reasonable interpretation, the appended claims refer to statutory subject matter in compliance with 35 U.S.C. §101.

What is claimed is:

1. A method for controlling a plurality of terminals using a gesture recognition, the method comprising:
recognizing a gesture by using an action sensor;
verifying an angle of a paired second terminal;
deciding an input signal by combining the gesture and the angle; and
controlling a first terminal in response to the decided input signal.

2. The method of claim 1, wherein recognizing a gesture by using an action sensor comprises recognizing a gesture by using one of an infrared sensor, a proximity sensor, a gyro sensor, an optical sensor, a motion sensor, a gravity sensor, an illumination sensor, or a camera.

3. The method of claim 1, wherein recognizing a gesture by using an action sensor comprises recognizing a gesture direction of an object by using the action sensor.

4. The method of claim 3, wherein verifying an angle of a paired second terminal comprises:
receiving a second gesture direction of a second terminal from the second terminal; and
verifying an angle difference between the first terminal and the second terminal based on a first gesture direction of the first terminal and a second gesture direction of the second terminal.

5. The method of claim 4, wherein deciding an input signal by combining the gesture and the angle comprises deciding an input signal with reference to the angle difference and an input table.

6. The method of claim 1, wherein controlling a first terminal in response to the decided input signal comprises transmitting a control signal corresponding to the control of the first terminal to the second terminal.

7. The method of claim 1, wherein controlling a first terminal in response to the decided input signal comprises copying a data stored in the first terminal to the second terminal.

8. The method of claim 1, wherein controlling a first terminal in response to the decided input signal comprises deleting a data stored in the first terminal and moving to the second terminal.

9. The method of claim 1, wherein controlling a first terminal in response to the decided input signal comprises canceling a data which is being executed in the first terminal.

10. The method of claim 1, wherein controlling a first terminal in response to the decided input signal comprises providing a link page of a page connected in the first terminal to the second terminal.

11. An apparatus for controlling a plurality of terminals using a gesture recognition, the apparatus comprising:
an action sensor to recognize a gesture of an object;
an angle verification unit to verify an angle of a paired second terminal;
an input decision unit to determine an input signal by combining the gesture and the angle; and
a controller to control a first terminal in response to the decided input signal.

12. The apparatus of claim 11, wherein the action sensor recognizes an action direction by using one of an infrared sensor, a proximity sensor, a gyro sensor, an optical sensor, a motion sensor, a gravity sensor, an illumination sensor, or a camera.

13. The apparatus of claim 12, wherein the angle verification unit verifies an angle difference between the first terminal and the second terminal based on a second action direction of the second terminal received from the second terminal and a first action direction of the first terminal.

14. The apparatus of claim 13, wherein the input decision unit decides an input signal with reference to the angle difference and an input table.

15. The apparatus of claim 11, wherein the controller transmits a control signal corresponding to the control of the first terminal to the second terminal.

16. The apparatus of claim 15, wherein the controller changes a data stored in the first terminal or a data stored in the second terminal according to the control signal.

17. The apparatus of claim 15, wherein the controller provides a link page of a page connected in the first terminal to the second terminal.

18. The apparatus of claim 11, wherein the gesture of the object is detected simultaneously by the action sensor and the paired second terminal.

19. The apparatus of claim 11, wherein the detection of the gesture of the object by the paired second terminal occurs within a threshold time of detecting the gesture by the action sensor.

20. The apparatus of claim 14, wherein within the input table the first function and the gesture are correlated to a range of angles, with which the detected angle falls.
